(19) United States
(12) Patent Application Publication
(10) Pub. No.: US 2026/0230255 A1
(43) Pub. Date: Aug. 6, 2026

(54) UPLINK SOUNDING REFERENCE SIGNAL TRANSMISSION MECHANISM

(71) Applicant: Nokia Technologies Oy, Espoo (FI)

(72) Inventors: Juha Pekka KARJALAINEN, Oulu (FI); Sami-Jukka HAKOLA, Oulu (FI); Timo KOSKELA, Oulu (FI); Youngsoo YUK, Seoul (KR)

(21) Appl. No.: 19/155,105

(22) PCT Filed: Jan. 22, 2024
(86) PCT No.: PCT/EP2024/051357

§ 371 Date: Aug. 8, 2025

(30) Foreign Application Priority Data
Feb. 14, 2023 (FI) 20235149

(51) Int. Cl. H04L 5/00

(52) U.S. Cl. CPC H04L 5/0048; H04L 5/0007

(57) ABSTRACT

Example embodiments of the present disclosure relate to a terminal device, a network device, methods, apparatuses and a computer readable storage medium for uplink sounding reference signal transmission. A terminal device may receive information indicating that multiple antenna port sets are time division multiplexed with each other across multiple OFDM symbols of an SRS resource in a slot. The terminal device may map the multiple antenna port sets into the multiple OFDM symbols of the SRS resource in the slot in a time division multiplexed manner. The terminal device may further transmit an SRS on the SRS resource in the slot. Thus, a transmission procedure for UL SRS with the information indicating that multiple antenna port sets are time division multiplexed with each other across multiple OFDM symbols of an SRS resource in a slot may be defined and the terminal device may transmit the UL SRS accordingly. Therefore, the resources of the multiple antenna port sets may be used in a more efficient manner.

### FIELD

Example embodiments of the present disclosure generally relate to the field of telecommunication and in particular, to a terminal device, a network device, methods, apparatuses and a computer readable storage medium for uplink (UL) sounding reference signal (SRS) transmission.

### BACKGROUND

The third generation project partner (3GPP) release 17 (Rel-17 or R17) has provided a support for both symmetric and non-symmetric UL SRS resource antenna-switching configurations, and R18 is proposed to extend the support for symmetric antenna-switching configuration by enabling 8 antenna ports (APs) with one or more orthogonal frequency division multiplexing (OFDM) symbols where different antenna ports are mapped to different symbols. However, a further study on a transmission of the UL SRS is still needed.

### SUMMARY

In general, example embodiments of the present disclosure provide a solution for uplink sounding reference signal transmission.

In a first aspect, there is provided an apparatus. The apparatus comprises at least one processor and at least one memory storing instructions that, when executed by the at least one processor, cause the apparatus at least to: receive, from a network device, information indicating that multiple antenna port sets are time division multiplexed with each other across multiple orthogonal frequency division multiplexing (OFDM) symbols of a sounding reference signal (SRS) resource in a slot; map the multiple antenna port sets into the multiple OFDM symbols of the SRS resource in the slot in a time division multiplexed manner based on the information; and transmit, to the network device, an SRS on the SRS resource, using the multiple antenna port sets.

In a second aspect, there is provided an apparatus. The apparatus comprises at least one processor and at least one memory storing instructions that, when executed by the at least one processor, cause the apparatus at least to: transmit, to a terminal device, information indicating that multiple antenna port sets are time division multiplexed with each other across multiple orthogonal frequency division multiplexing (OFDM) symbols of a sounding reference signal (SRS) resource in a slot; and receive, from the terminal device, an SRS on the SRS resource, wherein transmission of the SRS is based on the information.

In a third aspect, there is provided a method performed by a terminal device. The method comprises: receiving, by a terminal device and from a network device, information indicating that multiple antenna port sets are time division multiplexed with each other across multiple orthogonal frequency division multiplexing (OFDM) symbols of a sounding reference signal (SRS) resource in a slot; mapping, by the terminal device, the multiple antenna port sets into the multiple OFDM symbols of the SRS resource in the slot in a time division multiplexed manner based on the information; and transmitting, by the terminal device and to the network device, an SRS on the SRS resource, using the multiple antenna port sets.

In a fourth aspect, there is provided a method performed by a network device. The method comprises: transmitting, by a network device and to a terminal device, information indicating that multiple antenna port sets are time division multiplexed with each other across multiple orthogonal frequency division multiplexing (OFDM) symbols of a sounding reference signal (SRS) resource in a slot; and receiving, by the network device and from the terminal device, an SRS on the SRS resource, wherein transmission of the SRS is based on the information.

In a fifth aspect, there is provided an apparatus. The apparatus comprises: means for receiving, from a network device, information indicating that multiple antenna port sets are time division multiplexed with each other across multiple orthogonal frequency division multiplexing (OFDM) symbols of a sounding reference signal (SRS) resource in a slot; means for mapping the multiple antenna port sets into the multiple OFDM symbols of the SRS resource in the slot in a time division multiplexed manner based on the information; and means for transmitting, to the network device, an SRS on the SRS resource, using the multiple antenna port sets.

In a sixth aspect, there is provided an apparatus. The apparatus comprises: means for transmitting, at a network device to a terminal device, information indicating that multiple antenna port sets are time division multiplexed with each other across multiple orthogonal frequency division multiplexing (OFDM) symbols of a sounding reference signal (SRS) resource in a slot; and means for receiving, from the terminal device, an SRS on the SRS resource, wherein transmission of the SRS is based on the information.

In a seventh aspect, there is provided a non-transitory computer readable medium comprising program instructions that, when executed by an apparatus, cause the apparatus to perform at least the followings: receiving, from a network device, information indicating that multiple antenna port sets are time division multiplexed with each other across multiple orthogonal frequency division multiplexing (OFDM) symbols of a sounding reference signal (SRS) resource in a slot; mapping the multiple antenna port sets into the multiple OFDM symbols of the SRS resource in the slot in a time division multiplexed manner based on the information; and transmitting, to the network device, an SRS on the SRS resource, using the multiple antenna port sets.

In an eighth aspect, there is provided a non-transitory computer readable medium comprising program instructions that, when executed by an apparatus, cause the apparatus to perform at least the followings: transmitting, to a terminal device, information indicating that multiple antenna port sets are time division multiplexed with each other across multiple orthogonal frequency division multiplexing (OFDM) symbols of a sounding reference signal (SRS) resource in a slot; and receiving, from the terminal device, an SRS on the SRS resource, wherein transmission of the SRS is based on the information.

In a ninth aspect, there is provided a computer program comprising instructions, which, when executed by an apparatus, cause the apparatus to perform at least the followings: receiving, from a network device, information indicating that multiple antenna port sets are time division multiplexed with each other across multiple orthogonal frequency division multiplexing (OFDM) symbols of a sounding reference signal (SRS) resource in a slot; mapping the multiple antenna port sets into the multiple OFDM symbols of the SRS resource in the slot in a time division multiplexed manner based on the information; and transmitting, to the network device, an SRS on the SRS resource, using the multiple antenna port sets.

In a tenth aspect, there is provided a computer program comprising instructions, which, when executed by an apparatus, cause the apparatus to perform at least the followings: transmitting, to a terminal device, information indicating that multiple antenna port sets are time division multiplexed with each other across multiple orthogonal frequency division multiplexing (OFDM) symbols of a sounding reference signal (SRS) resource in a slot; and receiving, from the terminal device, an SRS on the SRS resource, wherein transmission of the SRS is based on the information.

In an eleventh aspect, there is provided a terminal device. The terminal device comprises: receiving circuitry configured to receive, from a network device, information indicating that multiple antenna port sets are time division multiplexed with each other across multiple orthogonal frequency division multiplexing (OFDM) symbols of a sounding reference signal (SRS) resource in a slot; mapping circuitry configured to map the multiple antenna port sets into the multiple OFDM symbols of the SRS resource in the slot in a time division multiplexed manner based on the information; and transmitting circuitry configured to transmit, to the network device, an SRS on the SRS resource, using the multiple antenna port sets.

In a twelfth aspect, there is provided a network device. The network device comprises: transmitting circuitry configured to transmit, to a terminal device, information indicating that multiple antenna port sets are time division multiplexed with each other across multiple orthogonal frequency division multiplexing (OFDM) symbols of a sounding reference signal (SRS) resource in a slot; and receiving circuitry configured to receive, from the terminal device, an SRS on the SRS resource, wherein transmission of the SRS is based on the information.

In a thirteenth aspect, there is provided a computer readable medium comprising program instructions that, when executed by an apparatus, cause the apparatus to perform at least the method in the third or fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example of UL SRS with usage ‘antennaSwitching’ 8T8R;

FIG. 2 illustrates an example of a UL SRS resource configuration with 8AP with comb-2 and without time division multiplexed (TDM:ed) antenna ports with resource set usage ‘codebook’;

FIG. 3 illustrates an example of a network environment in which some example embodiments of the present disclosure may be implemented;

FIG. 4 illustrates an example of a process flow in accordance with some example embodiments of the present disclosure;

FIG. 5 illustrates an example of multiple antenna port sets of an SRS resource mapped into multiple consecutive OFDM symbols in accordance with some example embodiments of the present disclosure;

FIG. 6 illustrates an example of multiple antenna port sets of an SRS resource mapped into multiple consecutive OFDM symbols with a repetition in accordance with some example embodiments of the present disclosure;

FIG. 7 illustrates an example of multiple antenna port sets of an SRS resource mapped into multiple non-consecutive OFDM symbols with a repetition in accordance with some example embodiments of the present disclosure;

FIG. 8 illustrates an example of multiple antenna port sets of an SRS resource mapped into multiple non-consecutive OFDM symbols with a repetition and a frequency hopping in accordance with some example embodiments of the present disclosure;

FIG. 9 illustrates a flowchart of a method implemented at a terminal device in accordance with some example embodiments of the present disclosure;

FIG. 10 illustrates a flowchart of a method implemented at a network device in accordance with some example embodiments of the present disclosure;

FIG. 11 illustrates a simplified block diagram of a device that is suitable for implementing some example embodiments of the present disclosure; and

FIG. 12 illustrates a block diagram of an example of a computer readable medium in accordance with some example embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), New Radio (NR), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a new radio (NR) NB (also referred to as a gNB), a Remote Radio Unit (RRU), a radio header (RH), a remote radio head (RRH), an integrated access and backhaul (IAB) node, a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a machine type communication (MTC) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

3GPP new radio (NR) Rel-17 specification provides support for single user downlink (DL) physical downlink shared channel (PDSCH) scheduling up to 8 layers (i.e. rank 8). However, Rel-15 UL SRS resource configuration with antenna switching can provide only support for user equipment (UEs) equipped with 4 RX antenna ports. In other words, even though a UE is equipped with 8 RX antenna ports, only 4 of the 8 antenna ports can be used for DL channel state information (CSI) acquisition at a network side (such as gNB-side) based on the UL SRS sounding. Clearly, this may lead to a suboptimal use of potential merits of DL TX precoding as well as RX processing, which limits the system performance e.g., in terms of spectral efficiency and interference mitigation.

NR Rel-17 supports the following SRS time domain behaviors: periodic, semi-persistent, and aperiodic transmissions. The periodic SRS resources may be configured by radio resource control (RRC) signaling. The semi-persistent set of one or more SRS resources may be activated or deactivated by a medium access control-control element (MAC CE). While being activated, semi-persistent SRS resource may be transmitted with a configured periodicity and a slot offset. As a result of this, more dynamic on/off control is enabled compared to the periodic SRS resources.

In Rel-17, depending on reported UE's antenna-switching capability, the UE can be configured with a higher layer parameter “usage” in SRS-ResourceSet set as “antennaSwitching”. The UE may be configured with only one of the following configurations depending on the indicated UE capability supportedSRS-TxPortSwitch:
‘t1r2’ for 1T2R,
‘t1r1-t1r2’ for 1T=1R/1T2R,
‘t2r4’ for 2T4R,
‘t1r4’ for 1T4R,
‘t1r6’ for 1T6R,
‘t1r8’ for 1T8R,
‘t2r6’ for 2T6R,
‘t2r8’ for 2T8R,
‘t4r8’ for 4T8R,
‘t1r1-t1r2-t1r4’ for 1T=1R/1T2R/1T4R,
‘t1r4-t2r4’ for 1T4R/2T4R,
‘tIr1-t1r2-t2r2-t2r4’ for 1T=1R/1T2R/2T=2R/2T4R,
‘t1r1-t1r2-t2r2-t1r4-t2r4’ for 1T=1R/1T2R/2T=2R/1T4R/2T4R,
‘t1r1’ for T=1R,
‘t2r2’ for 2T=2R,
‘t1r1-t2r2’ for 1T=1R/2T=2R,
‘t4r4’ for 4T=4R, or
‘t1r1-t2r2-t4r4’ for 1T=1R/2T=2R/4T=4R,
   where T and R define the number of transmission antenna ports and reception antenna ports at the UE-side, respectively. The indicated UE antenna switching capability (supportedSRS-TxPortSwitch) of ‘xTyR’ may refer to that a UE is capable of SRS transmission on ‘x’ antenna ports over total of ‘y’ antennas, where ‘y’ corresponds to all or a subset of UE receive antennas.

The UE is configured with a guard period of Y symbols, in which the UE does not transmit any other signal, in the case the SRS resources of a set are transmitted in the same slot. The guard period is in-between the SRS resources of the set. For two SRS resource sets of an antenna switching located in two consecutive slots, if the UE is capable of transmitting SRS in all symbols in one slot, a guard period of Y symbols exists between the last OFDM symbol occupied by the SRS resource set in the first slot and the first OFDM symbol occupied by the SRS resource set in the second slot.

For the inter-set guard period (or gap), the UE does not transmit any other signal on any symbol of the interval if the interval between two SRS resource sets is Y symbols.
When both the SRS resource on all of the corresponding symbols prior to the gap and the SRS resource on all of the corresponding symbols after the gap are dropped due to collision handling, the gap is also dropped with same priority and can be used for UL transmission.

The UE shall expect to be configured with the same number of SRS ports for all SRS resources in the SRS resource set(s) with higher layer parameter “usage” set as ‘antennaSwitching’.

For 1T2R, 1T4R, 2T4R, 1T6R, 1T8R, 2T6R, 2T8R, or 4T8R, the UE shall not expect to be configured or triggered with more than one SRS resource set with higher layer parameter “usage” set as ‘antennaSwitching’ in the same slot. For 1T=1R, 2T=2R, or 4T=4R, the UE shall not expect to be configured or triggered with more than one SRS resource set with higher layer parameter “usage” set as ‘antennaSwitching’ in the same symbol.

Additionally, Rel-17 defines a way how the antenna ports for the UL SRS resource are configured with/without repetition and with/without SRS frequency hopping:
When frequency hopping within an SRS resource in each slot is not configured with repetition (R=Ns), each of the antenna ports of the SRS resource in each slot is mapped in all the Ns symbols to the same set of subcarriers in the same set of physical resource blocks (PRBs), where R is an SRS repetition factor.
When frequency hopping within an SRS resource in each slot is configured without repetition (R=1), according to the SRS hopping parameters SRS B, SRS C, and hop b defined in clause 6.4.1.4 of 3GPP TS 38.211, each of the antenna ports of the SRS resource in each slot is mapped to different sets of subcarriers in each OFDM symbol, where the same transmission comb value is assumed for different sets of subcarriers.
When both frequency hopping and repetition within an SRS resource in each slot are configured (Ns≥4, R≥2), each of the antenna ports of the SRS resource in each slot is mapped to the same set of subcarriers within each set of R adjacent OFDM symbols, and frequency hopping across the Ns OFDM symbols is determined according to the SRS hopping parameters SRS B, SRS C and hop b, where Ns should be divisible by R, Ns defines the number of symbols and R is the repetition factor.

In Rel-18, it is important to identify and specify necessary enhancements for uplink multiple input multiple output (MIMO), while necessary enhancements on downlink MIMO that facilitate the use of large antenna array, not only for frequency range 1 (FR1) but also for FR2, would still need to be introduced to fulfil the request for evolution of NR deployments.

A higher peak data rate for UL could play a significant role in short-range applications such as home entertainment, video surveillance/monitoring in industrial/healthcare/safety, IAB, and other applications where devices power/form-factor/cost are not as stringent as in traditional handheld devices. UL transmission with >4Tx is useful to bridge the gap between DL and UL spectral efficiency, in both FR1 and FR2. Hence, there is a strong need to develop methods and/or signalling solutions to overcome this problem for Rel-18 or beyond releases.

The one of objectives of Rel-18 NR MIMO Evo DL UL, is to discuss and define how to provide specification support for simultaneous multi-panel UL transmission with 2 panels (ST×2P) as follows:
Study, and if justified, specify UL demodulation reference signal (DMRS), SRS, SRS resource indicator (SRI), and transmit precoding matrix indicator (TPMI) (including codebook) enhancements to enable 8 Tx UL operation to support 4 and more layers per UE in UL targeting customer premises equipment (CPE)/fixed wireless access (FWA)/vehicle/industrial devices. It is noted that potential restrictions on the scope of this objective (including coherence assumption, full/non-full power modes) will be identified as part of the study.

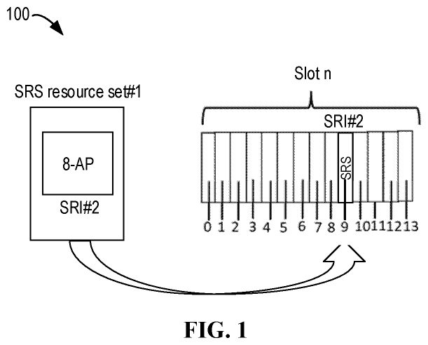

In RAN1 #110, it was agreed to use the existing value of the maximum number of SRS resource sets, for the maximum number of SRS resource sets for SRS with 8T8R with ‘antennaSwitching’. Additionally, it was agreed that 8 TX antenna ports will be supported in Rel-18 for UL SRS with usage ‘antennaSwitching’. Based on this, the UE can be configured with one OFDM symbol for 8 TX UL SRS with antenna-switching. FIG. 1 illustrates an example 100 of UL SRS with usage ‘antennaSwitching’ 8T8R. However, it remained for further study whether the UE can be configured more than one OFDM symbol, where different antenna ports are mapped to different symbols for 8 TX UL SRS with antenna-switching. Moreover, it remained for further study whether one or more OFDM symbol can be configured also for UL SRS usage with ‘codebook’.

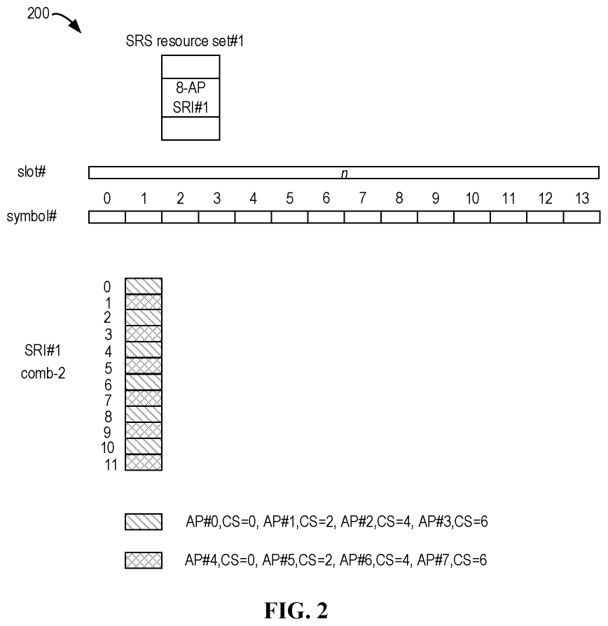

In RAN1 #111, it was agreed that the UE can be configured with 8AP SRS resource with resource set usage ‘codebook’ or ‘antennaSwitching’ at least with the following comb configurations:
For comb 2, support 1 and 2 comb offsets,
For comb 4, support 2 and 4 comb offsets,
For comb 8, support 4 comb offsets.
   For example, FIG. 2 illustrates an example 200 of a UL SRS resource configuration with 8AP with comb-2 and without time division multiplexed (TDM:ed) antenna ports with resource set usage ‘codebook’.

In RAN1#111 bis, it was agreed that 8TX codebook design will be support the following configurations:
For a single SRS resource in an SRS resource set with usage ‘codebook’ for 8TX physical uplink shared channel (PUSCH) or ‘antennaSwitching’ (i.e., for 8T8R antenna switching), when the SRS resource is configured with 8 ports and m OFDM symbols (m>1), support the case of 8 ports mapped onto the m OFDM symbols:
Option 1: Different SRS ports are mapped onto different OFDM; symbols (i.e., TDM).
FFS: m can be legacy values, i.e., 2, 4, 8, 10, 12, 14.

As discussed above, Rel-17 provides a support for both symmetric and non-symmetric UL SRS resource antenna-switching configurations xTyR, where symmetric ones having x=y=1,2,4 and non-symmetric ones having x≠y, x=1,2,4 and y=1,2,4,6,8, by using one or more OFDM symbols. Additionally, Rel-18 will extend the support for symmetric antenna-switching configuration by enabling support for x=y=8 with one or more OFDM symbols where different antenna ports are mapped to different symbols.

Furthermore, Rel-18 will also extend the support for UL SRS resource configuration with usage codebook and non-codebook for 8 TX antenna ports using one or more symbols where different antenna ports are mapped to different OFDM symbols. Moreover, Rel-18 will also provide support for UL SRS resource set configuration with usage ‘codebook/antenna-switching’ a single UL SRS resource configuration where multiple antenna ports, i.e., up to 8 APs, are distributed with TDM manner across time over multiple OFDM symbols.

However, there remains an ambiguity for the UE how to interpret correctly the indicated/configured UL SRS information (i.e., to distinguish operation with respect to legacy repetition and frequency hopping). Furthermore, it remains unclear what is the corresponding UE transmission procedure for UL SRS with given indicated information.

Example embodiments of the present disclosure provide a solution for uplink sounding reference signal transmission. Especially, a terminal device may receive information indicating that multiple antenna port sets are time division multiplexed with each other across multiple OFDM symbols of an SRS resource in a slot. The terminal device may map the multiple antenna port sets into the multiple OFDM symbols of the SRS resource in the slot in a time division multiplexed manner. The terminal device may further transmit an SRS on the SRS resource in the slot. Thus, a transmission procedure for UL SRS with the information indicating that multiple antenna port sets are time division multiplexed with each other across multiple OFDM symbols of an SRS resource in a slot may be defined and the terminal device may transmit the UL SRS accordingly. Therefore, the resources of the multiple antenna port sets may be used such way where transmission power associated with UL SRS resource can be used in a more efficient manner leading enhanced UL SRS coverage. Principles and some example embodiments of the present disclosure will be described in detail below with reference to the accompanying drawings.

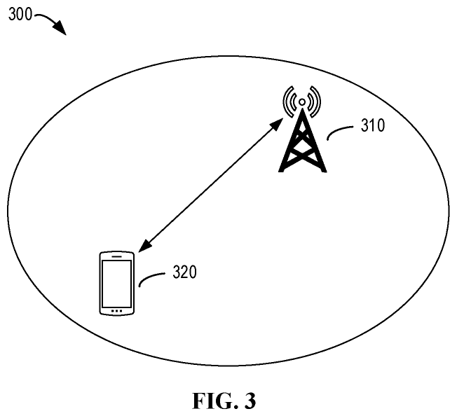

FIG. 3 illustrates an example of a network environment 300 in which some example embodiments of the present disclosure may be implemented. The environment 300, which may be a part of a communication network, comprises a network device 310 and a terminal device 320.

The communication environment 300 may comprise any suitable number of devices and cells. In the communication environment 300, the network device 310 can provide services to the terminal device 320, and the network device 310 and the terminal device 320 may communicate data and control information with each other. In some embodiments, the network device 310 and the terminal device 320 may communicate with direct links/channels.

In the environment 300, a link from the network device 310 to the terminal device 320 is referred to as a downlink (DL), while a link from the terminal device 320 to the network device 310 is referred to as an uplink (UL). In downlink, the network device 310 is a transmitting (TX) device (or a transmitter) and the terminal device 320 is a receiving (RX) device (or a receiver). In uplink, the terminal device 320 is a transmitting TX device (or a transmitter) and the network device 310 is a RX device (or a receiver). It is to be understood that the network device 310 may provide one or more serving cells. In some embodiments, the network device 310 can provide multiple cells.

Communications in the network environment 300 may be implemented according to any proper communication protocol(s), comprising, but not limited to, cellular communication protocols of the first generation (1G), the second generation (2G), the third generation (3G), the fourth generation (4G), the fifth generation (5G) and the sixth generation (6G) and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the numbers of devices (i.e., the terminal device 320 and the network device 310) and their connection relationships and types shown in FIG. 3 are only for the purpose of illustration without suggesting any limitation. For example, the environment 300 may include any suitable numbers of devices adapted for implementing embodiments of the present disclosure. For example, while FIG. 3 depicts the terminal device 320 as a mobile phone, the terminal device 320 may be any type of user equipment.

In some example embodiments, the network device 310 may use a flexible full duplex network or a dynamic TDD network. In some example embodiments, the terminal device 320 may support FDU, and the terminal device 320 may be a FDU-aware UE. In the present disclosure, the term “FDU-aware UE” may be used interchangeable with any one of the terms “mixed PRACH mode aware UE”, “mixed PRACH format aware UE”, “mixed PRACH capable UE”, “UE with mixed PRACH capability”, “UE with mix PRACH mode capability”, or the like, the present disclosure does not limit this aspect.

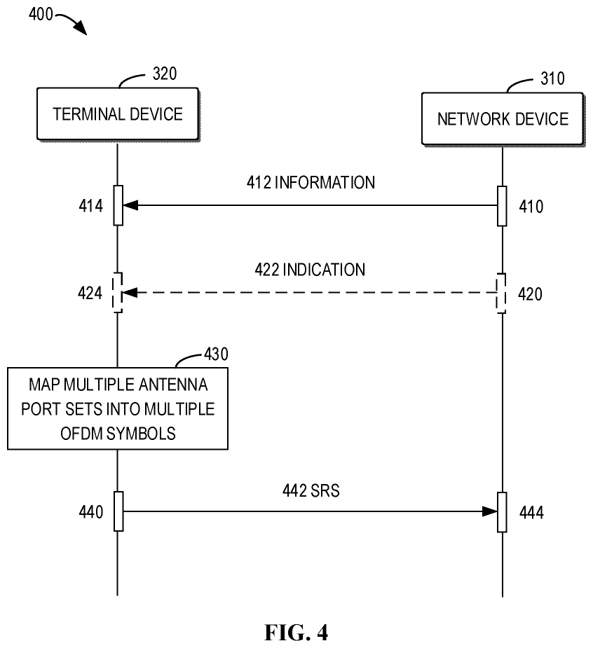

FIG. 4 illustrates an example of a process flow 400 in accordance with some example embodiments of the present disclosure. For the purpose of discussion, the process flow 400 will be described with reference to FIG. 3. The process flow 400 involves a network device 310 and a terminal device 320. It would be appreciated that although the process flow 400 has been described in the network environment 300 of FIG. 3, this process flow may be likewise applied to other communication scenarios.

The network device 310 transmits 410 information 412 to the terminal device 320, where the information 412 indicates whether multiple antenna port sets are time division multiplexed with each other across multiple OFDM symbols of an SRS resource in a slot.

In some example embodiments, the information 412 may be carried in a configuration, such as a new UL SRS resource configuration, and the information 412 may be in a new resource specific information element of the configuration. In some examples, the configuration may be transmitted via a radio resource control (RRC) message or RRC signalling. In some examples, the configuration may further include at least one of: a total number of antenna ports, a total number of the multiple OFDM symbols of the SRS resource in the slot, a starting position of the SRS resource, or a repetition factor.

For example, the total number of antenna ports may be represented as Nₛᵣₛ₋ₐₚ, and it may be indicated by an IE “numSRS-Ports” or “nrofSRS-Ports”. In one example, the IE “numSRS-Ports” or “nrofSRS-Ports” may be set as “ports8” to indicate that the total number of antenna ports is 8.

For example, the total number of the multiple OFDM symbols of the SRS resource in the slot may be represented as Ns, and it may be indicated by an IE “nrofSymbols” or “numofSymbols”. In one example, the IE “nrofSymbols” or “numofSymbols” may be set as “n2” to indicate that the total number of the multiple OFDM symbols of the SRS resource is 2. In another example, the IE “nrofSymbols” or “numofSymbols” may be set as “n4” to indicate that the total number of the multiple OFDM symbols of the SRS resource is 4.

For example, the starting position of the SRS resource may be indicated by an IE “startPosition”. The starting position of the SRS resource may refer to an index of the first OFDM symbol of the SRS resource in the slot, i.e., the first one of the multiple OFDM symbols within the slot. In one example, the IE “startPosition” may be set as “1” to indicate that the first OFDM symbol of the SRS resource is OFDM symbol 1.

For example, the repetition factor may be represented as R, and it may be indicated by an IE “repetitionFactor”. In one example, the IE “repetitionFactor” may be set as “n1” to indicate that there is no repetition configured. In another example, the IE “repetitionFactor” may be set as “n2” to indicate that a repetition is configured across 2 consecution OFDM symbols.

In some examples, the information 412 may be indicated by an information element, such as the IE “TDM-antennaPorts”. In some examples, the information 412 may be represented as a Boolean value. For example, the IE “TDM-antennaPorts” set as “TRUE” is used to indicate that the multiple antenna port sets are time division multiplexed with each other across multiple OFDM symbols of an SRS resource in a slot. For example, the IE “TDM-antennaPorts” set as “FALSE” is used to indicate that the multiple antenna port sets are not time division multiplexed with each other across multiple OFDM symbols of an SRS resource in a slot.

In some examples, the information 412, such as indicated by the IE “TDM-antennaPorts”, may be associated with the SRS resource, which may be called as, in the present disclosure, a target SRS resource, a target UL SRS resource, a targeted aperiodic SRS resource, a targeted aperiodic UL SRS resource, or the like.

On the other side of communication, the terminal device 320 receives the information 412 indicating whether multiple antenna port sets are time division multiplexed with each other across multiple OFDM symbols of an SRS resource in a slot.

In the present disclosure, it may be assumed that the information 412 indicates that multiple antenna port sets are time division multiplexed with each other across multiple OFDM symbols of an SRS resource in a slot, in other words, the multiple antenna port sets of a target SRS resource are TDM:ed across the multiple OFDM symbols within the slot. Accordingly, the terminal device 320 may determine the multiple antenna port sets should be TDM:ed across the multiple OFDM symbols within the slot.

In addition or alternatively, the terminal device 320 may determine a number of antenna ports in each of the multiple antenna port sets. In some example embodiments, the terminal device 320 may determine the number of antenna ports in each of the multiple antenna port sets based on one or more of: a total number of antenna ports, a total number of the multiple OFDM symbols, or a repetition factor. In some examples, the number of antenna ports in each of the multiple antenna port sets may equal to: Nₛᵣₛ₋ₐₚ/(Ns/R), where Nₛᵣₛ₋ₐₚ represents a total number of antenna ports of the SRS resource, Ns represents the total number of OFDM symbols, and R represents the repetition factor. In one example, if Nₛᵣₛ₋ₐₚ=8, Ns=2, and no repetition is configured (R=1), then the number of antenna ports in one antenna port set is 8/2=4, in other words, there are two antenna port sets each with 4 APs. In another example, if Nₛᵣₛ₋ₐₚ=8, Ns=4, and R=2, then the number of antenna ports in one antenna port set is 8/(4/2)=4, in other words, there are two antenna port sets each with 4 APs. For example, one antenna port set may include 4 APs with 4 lowest antenna port indexes, and the other antenna port set may include 4 APs with 4 highest antenna port indexes. For example, if the antenna port indexes of the Nₛᵣₛ₋ₐₚ=8 antenna ports are 0-7 respectively, then a first antenna port set include antenna ports with indexes 0-3, and a second antenna port set include antenna ports with indexes 4-7.

Continuing referring to FIG. 4, the network device 310 transmits 420 an indication 422 to the terminal device 320, where the indication 422 may indicate at least one offset value for the multiple antenna port sets of an SRS resource in a slot. In some example, the at least one offset value may be one or more offset values. In some examples, the indication 422 may be associated with the SRS resource. For example, there may be a different indication associated with a different SRS resource. In some examples, the indication 422 may be included in a MAC CE or in downlink control information (DCI).

In some example embodiments, the indication 422 may be transmitted in a MAC layer. In some examples, the indication 422 may be carried in a MAC CE. For examples, a specific field in the MAC CE may include the one or more offset values. For example, the specific field may be a new defined field or an existing field. For example, an existing field in the MAC CE may be used for carrying multiple SRS resource ID and corresponding multiple time offset values in a legacy specification, and the existing field may be overwritten to be the at least one offset value associated with the target SRS resource in the present disclosure.

In some other example embodiments, the indication 422 may be transmitted in a physical (PHY) layer. In some examples, the indication 422 may be carried in downlink control information (DCI) on a physical downlink control channel (PDCCH). As such, the indication 422 can be more dynamic with respect to RRC or MAC level signaling. For example, a specific codepoint field in the DCI may include the one or more offset values, where the specific codepoint field may be a new defined field (such as a new codepoint field) or an existing field (such as an existing codepoint field). For example, some reserved bits in the DCI may be defined as a new codepoint field, or some unused codepoint fields of the DCI may be repurposed for the indication 422. For example, an existing field in the DCI may be overwritten to be the at least one offset value associated with the target SRS resource.

In some other examples, the terminal device 320 may further receive a further indication indicating that the SRS resource is triggered. In some examples, the indication 422 and the further indication may be carried in different messages. For example, the indication 422 is carried in a DCI and the further indication is carried in a MAC CE.

In some other examples, the indication 422 and the further indication may be carried in a same message. For examples, the indication 422 and the further indication are carried in a same DCI. As such, a DCI may include the indication 422, and DCI may further include another indication to indicate that an aperiodic SRS resource set is triggered, where the aperiodic SRS resource set may be also referred to as a target SRS resource set or a target UL SRS resource set that includes the target SRS resource. For example, the DCI may include a codepoint field indicating the target aperiodic SRS resource set, for example, an ID of the target SRS resource set(s) is/are associated with an indicated value in the codepoint field. For examples, an existing codepoint field, such as an SRS-Request field or an SRS-Request-codepoint field, may be used to indicate a targeted aperiodic UL SRS resource set(s) and corresponding SRS resources, e.g., with DCI format 0_1.

In some examples, upon reception of DCI 0_1, the terminal device 320 may determine whether a value of the SRS-Request field (or the SRS-Request-codepoint field) indicates a target SRS resource (or a target SRS resource set including the target SRS resource) is triggered. If the target SRS resource set is triggered, the terminal device 320 may further obtain the indication 322 from another field (such as a new codepoint field) in the DCI, where the indication 322 indicate the one or more offset values associated with the target SRS resource.

In some example embodiments, each of the at least one offset value may be an integer value. In some examples, each of the at least one offset value may be less than a total number of OFDM symbols in a slot, for example, a slot may be with 14 OFDM symbols, and the integer may be any of 0-13.

In some example embodiments, the indication 422 (i.e., the at least one offset value) may be indicated by a specific IE, such as a new defined IE “antennaPortTimeOffset”.

In some example embodiments, the at least one offset value may include a single offset value. In this case, the single offset value is valid for all the multiple antenna port sets. In some examples, the single offset value may indicate an offset of OFDM symbols for two adjacent antenna port sets of the multiple antenna port sets. In some examples, the single offset value may indicate a difference of indexes of OFDM symbols associated with two adjacent antenna port sets. For example, a first antenna port set may be associated with OFDM x1, where x1 may be determined based on a starting position of the SRS resource, or x1 may be determined based on the starting position and the single offset value. For example, a second antenna port set may be associated with OFDM x2, where x2 may be determined based on x1 and the single offset value. It is understood that the multiple OFDM symbols in the slot are non-consecutive if the single offset value is not 0.

In some other example embodiments, the at least one offset value may include multiple offset values. In some examples, a number of the multiple offset values may be less than or equal to a number of the multiple antenna port sets.

In some examples, the multiple offset values may indicate multiple offsets of OFDM symbols for any two adjacent antenna port sets of the multiple antenna port sets. In some examples, the multiple offset values may indicate multiple differences of indexes of OFDM symbols associated with any two adjacent antenna port sets.

For example, a number of the multiple offset values may equal to the number of multiple antenna port sets. The first offset value may be associated with the first antenna port set, and may indicate an offset of the OFDM symbol associated with the first antenna port set relative to the starting position of the SRS resource. The ith, i>1, offset value may be associated with the ith antenna port set, and may indicate an offset of the OFDM symbol associated with the ith antenna port set relative to the OFDM symbol associated with the (i−1)th antenna port set. In one example, the first offset value may be 0, thus the first antenna port set may be associated with the starting position of the SRS resource, that is, the first OFDM symbol of the SRS resource.

For example, a number of the multiple offset values may equal to the number of multiple antenna port sets minus 1. The first antenna port set may be associated with the starting position of the SRS resource, that is, the first OFDM symbol of the SRS resource. The ith offset value may be associated with the (i+1)th antenna port set, and may indicate an offset of the OFDM symbol associated with the (i+1)th antenna port set relative to the OFDM symbol associated with the ith antenna port set.

In some other examples, the multiple offset values may indicate multiple offsets of OFDM symbols for multiple antenna port sets relative to the starting position of the SRS resource. In some examples, the multiple offset values may indicate multiple differences of indexes of OFDM symbols relative to the starting position of the SRS resource. In this case, the multiple offset values may be incremental.

For example, a number of the multiple offset values may equal to the number of multiple antenna port sets. The ith offset value may be associated with the ith antenna port set, and may indicate an offset of the OFDM symbol associated with the ith antenna port set relative to the starting position of the SRS resource. In one example, the first offset value may be 0, thus the first antenna port set may be associated with the starting position of the SRS resource, that is, the first OFDM symbol of the SRS resource.

For example, a number of the multiple offset values may equal to the number of multiple antenna port sets minus 1. The first antenna port set may be associated with the starting position of the SRS resource, that is, the first OFDM symbol of the SRS resource. The ith, i>1, offset value may be associated with the (i+1)th antenna port set, and may indicate an offset of the OFDM symbol associated with the (i+1)th antenna port set relative to the first OFDM symbol of the SRS resource.

In some examples, the at least one offset value may include multiple offset values, and the multiple offset values may be represented as a vector with multiple integer values. For example, two of the elements in the vector may be the same or different if the multiple offset values indicate multiple offsets of OFDM symbols for any two adjacent antenna port sets. For example, any two elements in the vector are different if the multiple offset values indicate multiple offsets of OFDM symbols for multiple antenna port sets relative to the starting position of the SRS resource.

In addition or alternatively, the network device 310 may transmit further information indicating whether the at least one offset value include only a single offset value. As such, the terminal device 320 may receive the further information and be aware of whether a single offset value is indicated in the indication 422.

Continuing referring to FIG. 4, on the other side of communication, the terminal device 320 receives 424 the indication 422 which indicate the one or more offset values for the multiple antenna port sets of the SRS resource in a slot.

The terminal device 320 maps 430 the multiple antenna port sets into the multiple OFDM symbols within the slot. In some examples, the multiple antenna port sets are equally distributed across the multiple OFDM symbols. In some examples, an OFDM symbol is associated with one of the multiple antenna port sets.

In some example embodiments, if the at least one offset value is not indicated or if the at least one offset value indicates 0, the multiple OFDM symbols are consecutive within the slot. In some other example embodiments, if the at least one offset value indicates one or more values other than 0, the multiple OFDM symbols are non-consecutive within the slot.

In some example embodiments, the terminal device 320 may determine multiple positions of the multiple OFDM symbols based on one or more of: a total number of: a total number of the multiple OFDM symbols, a starting position of a first OFDM symbol among the multiple OFDM symbols, the at least one offset value, or a repetition factor. In some examples, the multiple indexes of the multiple OFDM symbols within the slot may be determined. In some example embodiments, the terminal device 320 may map the multiple antenna port sets into the multiple positions of the multiple OFDM symbols.

It is to be understood that the multiple positions of the multiple OFDM symbols should be within the slot, if one of the positions are located beyond the slot, a configuration failure may occur.

Continuing referring to FIG. 4, the terminal device 320 transmits 440 an SRS 442 to the network device 310 on the SRS resource. And the network device 310 receives 444 the SRS 442. In some example embodiments, the terminal device 320 may transmit the SRS 442 on the SRS resource in the slot by using the multiple antenna port sets based on the mapping.

In some example embodiments, the terminal device 320 may transmit the SRS 442 by considering at least one of: whether the multiple antenna port sets are time division multiplexed, whether at least one offset value is indicated, whether a repetition is configured, or whether a frequency hopping is configured. In some examples, the multiple OFDM symbols are consecutive may refer to: all configured OFDM symbols are assumed to be consecutive or adjacent to each other. In some example embodiments, it is assumed that the information 412 indicates that the multiple antenna port sets are TDM:ed, for example, the IE “TDM-antennaPorts” is set as “TRUE”.

In some example embodiments, if the at least one offset value is not indicated or the at least one offset value includes a single offset value 0, the multiple OFDM symbols are consecutive, i.e., consecutive Ns OFDM symbols within the slot. In some other example embodiments, if the at least one offset value includes one or more offset value other than 0, the multiple OFDM symbols are non-consecutive, i.e., non-consecutive Ns OFDM symbols within the slot.

In some examples, if the frequency hopping within the SRS resource is not configured without repetition (such as, R=1), the terminal device 320 may map the multiple antenna port sets in the Ns OFDM symbols in an ascending order. In some examples, an antenna port set including antenna ports with smallest indices (antenna port indices) may be mapped to the first one of the Ns OFDM symbols. In some examples, the antenna ports with largest indices (antenna port indices) may be mapped to the last one of the Ns OFDM symbols. In some examples, the antenna ports may be configured to use a same comb-offset or different comb-offsets in the same set of PRBs.

In some example embodiments, if the frequency hopping within the SRS resource is not configured with a repetition (such as, R>1), the terminal device 320 may map the multiple antenna port sets in the Ns OFDM symbols in an ascending order, and further transmit the SRS associated with each of the multiple antenna port sets with a repetition across R consecutive symbols. In some examples, an antenna port set including antenna ports with smallest indices (antenna port indices) may be mapped to the first one of the Ns OFDM symbols. In some examples, the antenna ports with largest indices (antenna port indices) may be mapped to the last one of the Ns OFDM symbols. It is noted that Ns is divisible by R.

In some example embodiments, if the frequency hopping within the SRS resource is configured (such as, a hopping parameter b-SRS>0) without repetition (such as, R=1), the terminal device 320 may map the multiple antenna port sets in the Ns OFDM symbols in an ascending order, where an antenna port set including antenna ports with smallest indices (antenna port indices) may be mapped to the first one of the Ns OFDM symbols, and the antenna ports with largest indices (antenna port indices) may be mapped to the last one of the Ns OFDM symbols of a frequency hop.

In some example embodiments, if the frequency hopping within the SRS resource is configured (such as, a hopping parameter b-SRS>0) with a repetition (such as, R>1), the terminal device 320 may map the multiple antenna port sets in the Ns OFDM symbols in an ascending order, where an antenna port set including antenna ports with smallest indices (antenna port indices) may be mapped to the first one of the Ns OFDM symbols, and the antenna ports with largest indices (antenna port indices) may be mapped to the last one of the Ns OFDM symbols of a frequency hop, and additionally the SRS associated with each of the multiple antenna port sets is transmitted with a repetition across R consecutive symbols.

According to the embodiments, information 412 may be transmitted to indicate that multiple antenna port sets can be TDM:ed, as such, an SRS resource transmission may be enabled with TDM:ed antenna ports, in consecutive or non-consecutive OFDM symbols. In this event, a UL SRS transmission rule or procedure may be defined and the terminal device 320 may transmit the SRS according to the rule or procedure.

For ease of description, it is assumed that a total number of antenna ports is 8, for example, it may indicated by an IE “numSRS-Ports” or “nrofSRS-Ports”; and it is assumed that the multiple antenna port sets can be time division multiplexed with each other, for example, an IE “TDM-antennaPorts” is set as “TRUE”.

In some example embodiments, the specification in 3GPP TS 38.331 may be updated by including the content in Table 1:

```
TABLE 1
-- ASN1START
-- TAG-SRS-CONFIG-START
SRS-Config ::= SEQUENCE {
  --- void text ----
SRS-Resource ::= SEQUENCE {
          srs-ResourceId SRS-ResourceId,
          nrofSRS-Ports-r18 ENUMERATED {ports8},
          resourceMapping-r17 SEQUENCE {
              startPosition-r17 INTEGER (0..13),
              nrofSymbols-r17 ENUMERATED {n1, n2, n4, n8, n10,
n12, n14},
              repetitionFactor-r17 ENUMERATED {n1, n2, n4, n5,
n6, n7, n8, n10, n12, n14}
      },
        resourceMapping-r18 SEQUENCE {
            TDM-antennaPorts BOOLEAN
    },
}
--- void text ----
}
-- TAG-SRS-CONFIG-STOP
-- ASN1STOP
```

As shown above, the IE “nrofSRS-Ports-r18” is set as “ports8” to indicate that the total number of antenna ports is Nₛᵣₛ₋ₐₚ=8. As shown above, the IE “TDM-antennaPorts” may be used to indicate whether the multiple antenna port sets are time division multiplexed with each other, for example, it is assumed that the IE “TDM-antennaPorts” is set as “TRUE” to indicate that the multiple antenna port sets are TDM:ed.

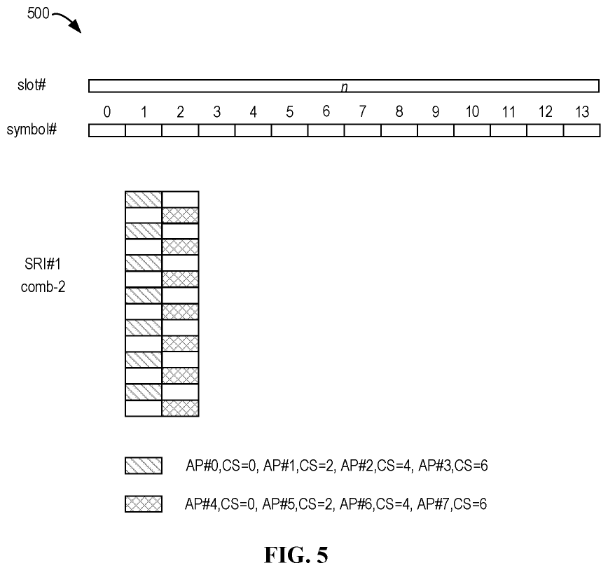

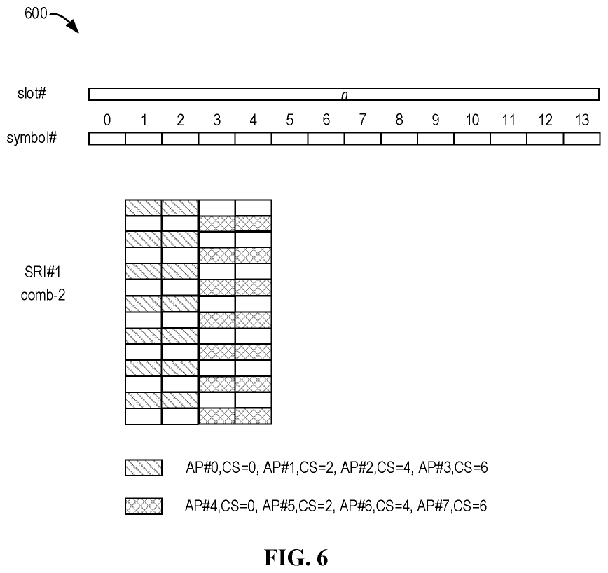

It is further assumed that the 8 antenna ports have indexes 0-7 respectively. It is noted that the at least one offset value is not indicated, for example, there is no IE “antennaPortTimeOffset” included in Table 1, as such, the multiple OFDM symbols are consecutive. FIGS. 5-6 illustrate some examples of multiple antenna port sets of an SRS resource mapped into multiple consecutive OFDM symbols.

FIG. 5 illustrates an example 500 of multiple antenna port sets of an SRS resource mapped into multiple consecutive OFDM symbols in accordance with some example embodiments of the present disclosure. In the example 500, it is assumed that a repetition is not configured (for example, an IE “repetitionFactor-r17” in Table 1 is set as “n1”, i.e., R=1). It is also assumed that the number of OFDM symbols is configured as Ns=2 (for example, an IE “nrofSymbols-r17” in Table 1 is set as “n2”), and the starting OFDM symbol is configured as 1 (for example, an IE “startPosition-r17” in Table 1 is set as “1”). As such, the terminal device 320 may determine that the SRS resource includes the consecutive OFDM symbols with indexes 1 and 2.

The terminal device 320 may determine that each of the multiple antenna port sets includes Nₛᵣₛ₋ₐₚ/(Ns/R)=8/(2/1)=4 antenna ports. In other words, there are two antenna port sets, one antenna port set includes antenna ports 0-3 and the other antenna port set includes antenna ports 4-7.

The terminal device 320 may determine that the total number of antenna ports (i.e., 8 APs) are equally distributed across the multiple OFDM symbols (i.e., Ns=2 OFDM symbols). In some examples, each OFDM symbol may be associated with one antenna ports set. For example, the terminal device 320 may determine that an antenna port set with lowest antenna port index (indexes) are configured to be used for the first OFDM symbol, and an antenna port set with highest antenna port index (indexes) are configured to be used for the last OFDM symbol.

As shown in FIG. 5, OFDM symbol 1 is associated with an antenna port set including antenna ports 0-3, and OFDM symbol 2 is associated with an antenna port set including antenna ports 4-7. As such, the terminal device 320 may use antenna ports 0-3 for OFDM symbol 1 and use antenna ports 4-7 for OFDM symbol 2, to transmit an SRS.

FIG. 6 illustrates an example 600 of multiple antenna port sets of an SRS resource mapped into multiple consecutive OFDM symbols with repetition in accordance with some example embodiments of the present disclosure. In the example 600, it is assumed that a repetition (R>1) is configured (for example, an IE “repetitionFactor-r17” in Table 1 is set as “n2”, i.e., R=2). It is also assumed that the number of OFDM symbols is configured as Ns=4 (for example, an IE “nrofSymbols-r17” in Table 1 is set as “n4”), and the starting OFDM symbol is configured as 1 (for example, an IE “startPosition-r17” in Table 1 is set as “1”). As such, the terminal device 320 may determine that the SRS resource includes the consecutive OFDM symbols with indexes 1 through 4.

The terminal device 320 may determine that each of the multiple antenna port sets includes Nₛᵣₛ₋ₐₚ/(Ns/R)=8/(4/2)=4 antenna ports. In other words, there are two antenna port sets, one antenna port set includes antenna ports 0-3 and the other antenna port set includes antenna ports 4-7.

The terminal device 320 may determine that the total number of antenna ports (i.e., 8 APs) are equally distributed across the multiple OFDM symbols (i.e., Ns=4 OFDM symbols) with a repetition across R=2 consecutive OFDM symbols. In some examples, each OFDM symbol may be associated with one antenna ports set. For example, the terminal device 320 may determine that an antenna port set with lowest antenna port index (indexes) are configured to be used for the first OFDM symbol, and an antenna port set with highest antenna port index (indexes) are configured to be used for the last OFDM symbol.

As shown in FIG. 6, OFDM symbols 1 and 2 are associated with an antenna port set including antenna ports 0-3, and OFDM symbols 3 and 4 are associated with an antenna port set including antenna ports 4-7. As such, the terminal device 320 may use antenna ports 0-3 for OFDM symbol 1/2 (in other words, the antenna ports 0-3 are configured to be repeated in the first two OFDM symbols 1-2) and use antenna ports 4-7 for OFDM symbol 3/4 (in other words, the antenna ports 4-7 are configured to be repeated in the last two OFDM symbols 3-4), to transmit an SRS.

In some example embodiments, the specification in 3GPP TS 38.331 may be updated by including the content in Table 1:

```
TABLE 2
-- ASN1START
-- TAG-SRS-CONFIG-START
SRS-Config ::= SEQUENCE {
  --- void text ----
SRS-Resource ::= SEQUENCE {
          srs-ResourceId SRS-ResourceId,
          nrofSRS-Ports-r18 ENUMERATED {ports8},
          resourceMapping-r17 SEQUENCE {
              startPosition-r17 INTEGER (0..13),
              nrofSymbols-r17 ENUMERATED {n1, n2, n4, n8, n10,
n12, n14},
              repetitionFactor-r17 ENUMERATED {n1, n2, n4, n5,
n6, n7, n8, n10, n12, n14}
      },
        resourceMapping-r18 SEQUENCE {
            TDM-antennaPorts BOOLEAN
            antennaPortTimeOffset INTEGER (0..13)
            %comment: antennaPortTimeOffset =0: consecutive
OFDM symbols and antennaPortTimeOffset >0: non-consecutive OFDM
symbols
    },
}
--- void text ----
}
-- TAG-SRS-CONFIG-STOP
-- ASN1STOP
```

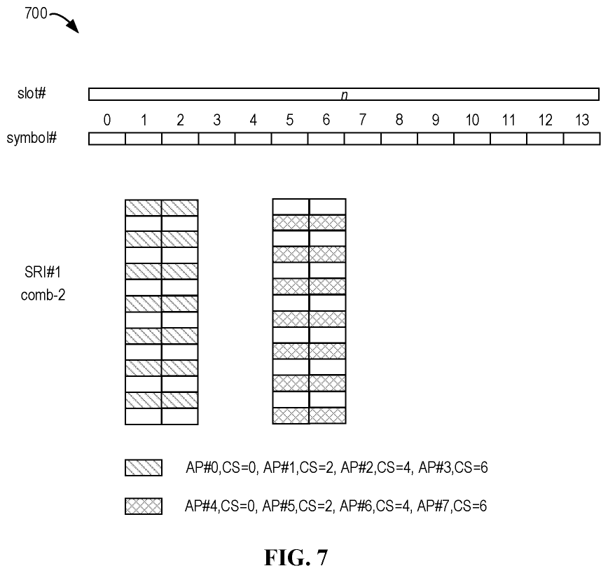

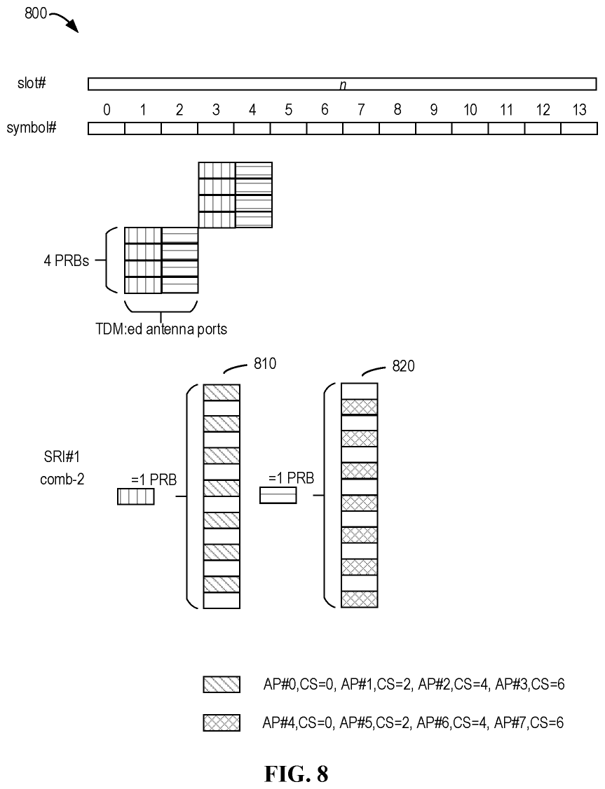

As shown above, the IE “nrofSRS-Ports-r18” is set as “ports8” to indicate that the total number of antenna ports is Nₛᵣₛ₋ₐₚ=8. As shown above, the IE “TDM-antennaPorts” may be used to indicate whether the multiple antenna port sets are time division multiplexed with each other, for example, it is assumed that the IE “TDM-antennaPorts” is set as “TRUE” to indicate that the multiple antenna port sets are TDM:ed. As shown in Table 2, the IE “antennaPortTimeOffset” is used to indicate at least one offset value, such as a single offset value. It is assumed that the single offset value is not 0 in this case, as such, the multiple OFDM symbols are non-consecutive. FIGS. 7-8 illustrate some examples of multiple antenna port sets of an SRS resource mapped into multiple non-consecutive OFDM symbols.

FIG. 7 illustrates an example 700 of multiple antenna port sets of an SRS resource mapped into multiple non-consecutive OFDM symbols with a repetition in accordance with some example embodiments of the present disclosure. In the example 700, it is assumed that the one or more offset values include a single offset value equaling to an integer 4 (for example, an IE “antennaPortTimeOffset” in Table 2 is set as “4”), and a repetition is configured (for example, an IE “repetitionFactor-r17” in Table 2 is set as “n2”, i.e., R=2). It is also assumed that the number of OFDM symbols is configured as Ns=4 (for example, an IE “nrofSymbols-r17” in Table 2 is set as “n4”), and the starting OFDM symbol is configured as 1 (for example, an IE “startPosition-r17” in Table 2 is set as “1”). As such, the terminal device 320 may determine that the SRS resource includes the non-consecutive OFDM symbols with indexes 1-2 and 5-6, where an offset between the OFDM symbol 5 for a second antenna port set and the OFDM symbol 1 for a first antenna port set is 4.

The terminal device 320 may determine that each of the multiple antenna port sets includes Nₛᵣₛ₋ₐₚ/(Ns/R)=8/(4/2)=4 antenna ports. In other words, there are two antenna port sets, one antenna port set includes antenna ports 0-3 and the other antenna port set includes antenna ports 4-7.

The terminal device 320 may determine that the total number of antenna ports (i.e., 8 APs) are equally distributed across the multiple OFDM symbols (i.e., Ns=4 OFDM symbols) with a repetition across R=2 consecutive OFDM symbols. In some examples, each OFDM symbol may be associated with one antenna ports set. For example, the terminal device 320 may determine that an antenna port set with lowest antenna port index (indexes) are configured to be used for the first OFDM symbol, and an antenna port set with highest antenna port index (indexes) are configured to be used for the last OFDM symbol.

As shown in FIG. 7, OFDM symbols 1 and 2 are associated with an antenna port set including antenna ports 0-3, and OFDM symbols 5 and 6 are associated with an antenna port set including antenna ports 4-7. As such, the terminal device 320 may use antenna ports 0-3 for OFDM symbol 1-2 (in other words, the antenna ports 0-3 are configured to be repeated in the first two OFDM symbols 1-2) and use antenna ports 4-7 for OFDM symbol 5-6 (in other words, the antenna ports 4-7 are configured to be repeated in the last two OFDM symbols 5-6), to transmit an SRS.

FIG. 8 illustrates an example 800 of multiple antenna port sets of an SRS resource mapped into multiple OFDM symbols with a repetition and a frequency hopping in accordance with some example embodiments of the present disclosure. In the example 800, it is assumed that the one or more offset values include a single offset value equaling to an integer 2 (for example, an IE “antennaPortTimeOffset” in Table 2 is set as “2”), and a repetition is not configured (for example, an IE “repetitionFactor-r17” in Table 2 is set as “n1”, i.e., R=1). It is also assumed that the number of OFDM symbols is configured as Ns=4 (for example, an IE “nrofSymbols-r17” in Table 2 is set as “n4”), and the starting OFDM symbol is configured as 1 (for example, an IE “startPosition-r17” in Table 2 is set as “1”). It is further assumed that a frequency hopping is configured, for example, a hopping parameter b-SRS>0. In some examples, the hopping parameter may include c-SRS and b-SRS, the combination thereof corresponds to an SRS transmission bandwidth and a number of hops. In one example as shown in FIG. 8, it is assumed that c-SRS=1 and b-SRS=1, thus there are two hops each with 4 PRBs. When UL SRS resource is configured with TDM:ed antenna port multiplexing with consecutive OFDM symbols (TDM-antennaPorts=‘TRUE’ and antennaPortTimeOffset=0) with frequency hopping b-SRS>0, each set of antenna port of the SRS resource are mapped to the same set of subcarriers for a first frequency hop within two adjacent OFDM symbols of the SRS resource in each slot. After the first frequency hop, new set of subcarriers for a second frequency hop (i.e., different set of subcarriers with respect to set of subcarriers associated with the first frequency hop) is associated with each set of antenna port of the SRS resource with other two adjacent OFDM symbols being adjacent to previous OFDM symbols associated with previous frequency hop (i.e., the first frequency hop).

The terminal device 320 may determine that each of the multiple antenna port sets includes Nₛᵣₛ₋ₐₚ/(Ns/R)=8/(4/2)=4 antenna ports. In other words, there are two antenna port sets, one antenna port set includes antenna ports 0-3 and the other antenna port set includes antenna ports 4-7.

The terminal device 320 may determine that the total number of antenna ports (i.e., 8 APs) are equally distributed across the multiple OFDM symbols (i.e., Ns=4 OFDM symbols) with a repetition across R=2 consecutive OFDM symbols. In some examples, each OFDM symbol may be associated with one antenna ports set. For example, the terminal device 320 may determine that an antenna port set with lowest antenna port index (indexes) are configured to be used for the first OFDM symbol, and an antenna port set with highest antenna port index (indexes) are configured to be used for the last OFDM symbol of a frequency hop.

As shown in FIG. 8, the antenna ports for one PRB of the first hop and the antenna ports for one PRB of the second hop may be represented as 810 and 820 respectively.

It is to be understood that the examples shown in FIGS. 5-8 are only for illustration without any limitation. For example, each of the examples shown in FIGS. 5-8 is associated with an SRS resource in a slot, such as slot #n, including 14 OFDM symbols, such OFDM symbols 0-13. For example, the comb offset 1 for comb-2 is used in each of the examples shown in FIGS. 5-8. However, it is to be understood that some modifications may be made thereon and the present disclosure does not limit this aspect.

The embodiments with reference to FIGS. 4-8 are described with respect to an SRS resource (i.e., a target SRS resource), it is understood that the terminal device 320 is equipped with an SRS resource set including the target SRS resource. For example, the SRS resource set may be an SRS resource set #1, and the target SRS resource may be with SRI #1. According to the embodiments, Enables an SRS resource transmission with TDM:ed antenna ports in consecutive or non-consecutive OFDM symbols is enabled at the terminal device. The network device may flexibly schedule or dynamically indicate a distribution of the multiple antenna port sets within a slot, such as by an indication indicating at least one offset value, so as to enhance an SRS transmission coverage with SRS resource usage set to ‘codebook’. Additionally, it enables to use the TDM:ed antenna port sets for an SRS transmission with a repetition and/or a frequency hopping.

In some other examples, the terminal device 320 may be equipped with multiple transmit antenna panels (e.g., to operate with higher carrier frequencies, e.g., FR2) with different transmission capabilities (e.g., in terms of maximum transmission power per antenna panel). The terminal device 320 may be configured with one or more SRS resource sets with usage ‘codebook’, where each SRS resource set may include SRS resources either with TDM:ed or non-TDM:ed antenna ports according to each TX antenna panel capabilities. For example, the terminal device 320 may be configured with a first SRS resource set and a second SRS resource set. The first SRS resource set may include an SRS resource with TDM:ed antenna ports, for example, with antenna panels with smaller maximum power capabilities. The second SRS resource set may include an SRS resource with non-TDM:ed antenna ports (legacy way), for example, with antenna panels with higher maximum power capabilities. As a result, similar coverage can be achieved with UL SRS transmission from different antenna panels with the price of additional latency and overhead associated with TDM:ed antenna ports. Despite of aforementioned aspects, it may be still very beneficial from system perspective to enable such configurations for enhancing UL SRS coverage. As such, it is possible to configure different TDM patterns for the terminal device equipped with different antenna panel transmission capabilities.

It is to be understood that the embodiments described with reference to FIGS. 4-8 are only for the purpose of illustration without any limitation, some other embodiments may still be within the scope of the present disclosure. In some examples, the information 412 in FIG. 4 may be omitted or optional in some cases. In some examples, the network device 310 transmits an indication to the terminal device 320, accordingly the terminal device 320 receives an indication from the network device 310, where the indication indicates one or more offset values for multiple antenna port sets of an SRS resource in a slot. In some examples, the terminal device 320 may be equipped with TDM:ed antenna ports. In some examples, the terminal device 320 may be determine how multiple set of antenna ports are time division multiplexed, based on the indication. As a result, multiple antenna port sets may be mapped to corresponding OFDM symbols based on the indication, and therefore, a better UL SRS coverage may be achieved.

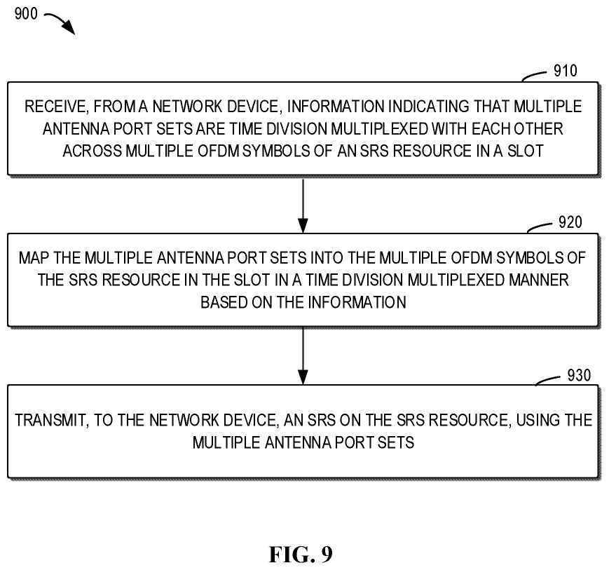

FIG. 9 illustrates a flowchart 900 of a method implemented at a terminal device in accordance with some example embodiments of the present disclosure. For the purpose of discussion, the method 900 will be described from the perspective of the terminal device 320 with reference to FIG. 3.

At block 910, the terminal device 320 receives, from a network device, information indicating that multiple antenna port sets are time division multiplexed with each other across multiple OFDM symbols of an SRS resource in a slot. At block 920, the terminal device 320 maps the multiple antenna port sets into the multiple OFDM symbols of the SRS resource in the slot in a time division multiplexed manner based on the information. At block 930, the terminal device 320 transmits, to the network device, an SRS on the SRS resource, using the multiple antenna port sets.

In some example embodiments, the terminal device 320 equally distributes the multiple antenna port sets across the multiple OFDM symbols, where each of the multiple OFDM symbols is associated with one of the multiple antenna port sets, and where the multiple OFDM symbols are consecutive in the slot.

In some example embodiments, the terminal device 320 receives, from the network device, an indication indicating at least one offset value for the multiple antenna port sets in the slot.

In some example embodiments, each of the at least one offset value indicates an offset number of OFDM symbols between two adjacent antenna port sets of the multiple antenna port sets in the slot.

In some example embodiments, the at least one offset value comprises multiple offset values, and where each of the multiple offset values indicates an offset number of OFDM symbols relative to a first OFDM symbol of the SRS resource.

In some example embodiments, the multiple offset values are represented as a vector with multiple different integer values.

In some example embodiments, the indication is comprised in at least one of: a MAC CE, or a DCI.

In some example embodiments, the terminal device 320 receives, from the network device, a further indication indicating that the SRS resource is triggered.

In some example embodiments, if the at least one offset value is larger than 0, the terminal device 320 equally distributes the multiple antenna port sets across the multiple OFDM symbols, where each of the multiple OFDM symbols is associated with one of the multiple antenna port sets, and where the multiple OFDM symbols are non-consecutive in the slot.

In some example embodiments, the terminal device 320 determines multiple positions of the multiple OFDM symbols in the slot based on at least one of: a total number of the multiple OFDM symbols, a starting position of a first OFDM symbol among the multiple OFDM symbols, the at least one offset value, or a repetition factor.

In some example embodiments, if a repetition is configured or a frequency hopping is configured, the terminal device 320 maps the multiple antenna port sets into the multiple OFDM symbols based on at least one of: a repetition factor, or one or more hopping parameters.

In some example embodiments, the terminal device 320 determines a number of antenna ports in each of the multiple antenna port sets based on at least one of: a total number of antenna ports at the apparatus, a total number of the multiple OFDM symbols, or a repetition factor.

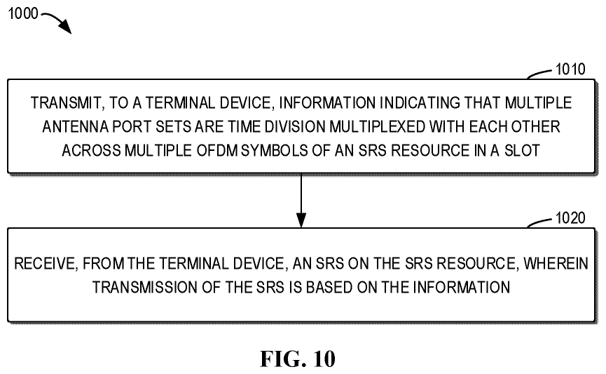

FIG. 10 illustrates a flowchart 1000 of a method implemented at a network device in accordance with some example embodiments of the present disclosure. For the purpose of discussion, the method 1000 will be described from the perspective of the network device 310 with reference to FIG. 3.

At block 1010, the network device 310 transmits, to a terminal device, information indicating that multiple antenna port sets are time division multiplexed with each other across multiple OFDM symbols of an SRS resource in a slot. At block 1020, the network device 310 receives, from the terminal device, an SRS on the SRS resource, where a transmission of the SRS is based on the information.

In some example embodiments, each of the multiple OFDM symbols is associated with one of the multiple antenna port sets, and the multiple OFDM symbols are consecutive in the slot.

In some example embodiments, the network device 310 transmits, to the terminal device, an indication indicating at least one offset value for the multiple antenna port sets in the slot.

In some example embodiments, the at least one offset value indicates an offset number of OFDM symbols between two adjacent antenna port sets of the multiple antenna port sets in the slot.

In some example embodiments, the at least one offset value comprises multiple offset values, and each of the multiple offset values indicates an offset number of OFDM symbols relative to a first OFDM symbol of the SRS resource.

In some example embodiments, the multiple offset values are represented as a vector with multiple different integer values.

In some example embodiments, the indication is comprised in at least one of: a MAC CE, or a DCI.

In some example embodiments, the network device 310 transmits, to the terminal device, a further indication indicating that the SRS resource is triggered.

In some example embodiments, each of the multiple OFDM symbols is associated with one of the multiple antenna port sets, where the at least one offset value is larger than 0 and the multiple OFDM symbols are non-consecutive in the slot.

In some example embodiments, multiple positions of the multiple OFDM symbols in the slot is determined based on at least one of: a total number of the multiple OFDM symbols, a starting position of a first OFDM symbol among the multiple OFDM symbols, the at least one offset value, or a repetition factor if the repetition is configured.

In some example embodiments, the multiple antenna port sets are mapped into the multiple OFDM symbols based on at least one of: a repetition factor if the repetition is configured, or one or more hopping parameters if the frequency hopping is configured.

In some example embodiments, a number of antenna ports in each of the multiple antenna port sets is determined based on at least one of: a total number of antenna ports at the apparatus, a total number of the multiple OFDM symbols, or a repetition factor.

In some example embodiments, an apparatus (for example, the terminal device 320) comprises at least one processor; and at least one memory storing instructions that, when executed by the at least one processor, cause the apparatus at least to: receive, from a network device, information indicating that multiple antenna port sets are time division multiplexed with each other across multiple orthogonal frequency division multiplexing, OFDM, symbols of a sounding reference signal, SRS, resource in a slot; map the multiple antenna port sets into the multiple OFDM symbols of the SRS resource in the slot in a time division multiplexed manner based on the information; and transmit, to the network device, an SRS on the SRS resource, using the multiple antenna port sets.

In some example embodiments, the apparatus is caused to map the multiple antenna port sets into the multiple OFDM symbols by: equally distributing the multiple antenna port sets across the multiple OFDM symbols, wherein each of the multiple OFDM symbols is associated with one of the multiple antenna port sets, and wherein the multiple OFDM symbols are consecutive in the slot.

In some example embodiments, the apparatus is further caused to: receive, from the network device, an indication indicating at least one offset value for the multiple antenna port sets in the slot.

In some example embodiments, each of the at least one offset value indicates an offset number of OFDM symbols between two adjacent antenna port sets of the multiple antenna port sets in the slot.

In some example embodiments, the at least one offset value comprises multiple offset values, and wherein each of the multiple offset values indicates an offset number of OFDM symbols relative to a first OFDM symbol of the SRS resource.

In some example embodiments, the multiple offset values are represented as a vector with multiple different integer values.

In some example embodiments, the apparatus is further caused to: receive, from the network device, a further indication indicating that the SRS resource is triggered.

In some example embodiments, the apparatus is caused to map the multiple antenna port sets into the multiple OFDM symbols by: determining that the at least one offset value is larger than 0; and based on the determining that the at least one offset value is larger than 0, equally distributing the multiple antenna port sets across the multiple OFDM symbols, wherein each of the multiple OFDM symbols is associated with one of the multiple antenna port sets, and wherein the multiple OFDM symbols are non-consecutive in the slot.

In some example embodiments, the apparatus is further caused to: determine multiple positions of the multiple OFDM symbols in the slot based on at least one of: a total number of the multiple OFDM symbols, a starting position of a first OFDM symbol among the multiple OFDM symbols, the at least one offset value, or a repetition factor.

In some example embodiments, the apparatus is caused to map the multiple antenna port sets into the multiple OFDM symbols by: determining that a repetition is configured or a frequency hopping is configured; and based on the determining that the repetition is configured or the frequency hopping is configured, mapping the multiple antenna port sets into the multiple OFDM symbols based on at least one of: a repetition factor, or one or more hopping parameters.

In some example embodiments, the apparatus is further caused to: determine a number of antenna ports in each of the multiple antenna port sets based on at least one of: a total number of antenna ports at the apparatus, a total number of the multiple OFDM symbols, or a repetition factor.

In some example embodiments, an apparatus (for example, the network device 310) comprises at least one processor; and at least one memory storing instructions that, when executed by the at least one processor, cause the apparatus at least to: transmit, to a terminal device, information indicating that multiple antenna port sets are time division multiplexed with each other across multiple orthogonal frequency division multiplexing, OFDM, symbols of a sounding reference signal, SRS, resource in a slot; and receive, from the terminal device, an SRS on the SRS resource, wherein transmission of the SRS is based on the information.

In some example embodiments, the apparatus is further caused to: transmit, to the terminal device, an indication indicating at least one offset value for the multiple antenna port sets in the slot.

In some example embodiments, an apparatus capable of performing the method 900 (for example, the terminal device 320) may comprise means for performing the respective steps of the method 900. The means may be implemented in any suitable form. For example, the means may be implemented in a circuitry or software module.

In some example embodiments, the apparatus comprises: means for receiving, from a network device, information indicating that multiple antenna port sets are time division multiplexed with each other across multiple OFDM symbols of an SRS resource in a slot; means for mapping the multiple antenna port sets into the multiple OFDM symbols of the SRS resource in the slot in a time division multiplexed manner based on the information; and means for transmitting, to the network device, an SRS on the SRS resource, using the multiple antenna port sets.

In some example embodiments, means for mapping the multiple antenna port sets into the multiple OFDM symbols of the SRS resource in the slot in a time division multiplexed manner based on the information comprises: means for equally distributing the multiple antenna port sets across the multiple OFDM symbols, wherein each of the multiple OFDM symbols is associated with one of the multiple antenna port sets, and wherein the multiple OFDM symbols are consecutive in the slot.

In some example embodiments, the apparatus further comprises: means for receiving, from the network device, an indication indicating at least one offset value for the multiple antenna port sets in the slot.

In some example embodiments, each of the at least one offset value indicates an offset number of OFDM symbols between two adjacent antenna port sets of the multiple antenna port sets in the slot.

In some example embodiments, the at least one offset value comprises multiple offset values, and wherein each of the multiple offset values indicates an offset number of OFDM symbols relative to a first OFDM symbol of the SRS resource.

In some example embodiments, the multiple offset values are represented as a vector with multiple different integer values.

In some example embodiments, the indication is comprised in at least one of: a MAC CE, or a DCI.

In some example embodiments, the apparatus further comprises: means for receiving, from the network device, a further indication indicating that the SRS resource is triggered.

In some example embodiments, means for mapping the multiple antenna port sets into the multiple OFDM symbols of the SRS resource in the slot in a time division multiplexed manner based on the information comprises: means for determining that the at least one offset value is larger than 0; and means for based on the determining that the at least one offset value is larger than 0, equally distributing the multiple antenna port sets across the multiple OFDM symbols, wherein each of the multiple OFDM symbols is associated with one of the multiple antenna port sets, and wherein the multiple OFDM symbols are non-consecutive in the slot.

In some example embodiments, the apparatus further comprises: means for determining multiple positions of the multiple OFDM symbols in the slot based on at least one of: a total number of the multiple OFDM symbols, a starting position of a first OFDM symbol among the multiple OFDM symbols, the at least one offset value, or a repetition factor.

In some example embodiments, means for mapping the multiple antenna port sets into the multiple OFDM symbols of the SRS resource in the slot in a time division multiplexed manner based on the information comprises: means for determining that a repetition is configured or a frequency hopping is configured; and means for based on the determining that the repetition is configured or a frequency hopping is configured, mapping the multiple antenna port sets into the multiple OFDM symbols based on at least one of: a repetition factor, or one or more hopping parameters.

In some example embodiments, the apparatus further comprises: means for determining a number of antenna ports in each of the multiple antenna port sets based on at least one of: a total number of antenna ports at the apparatus, a total number of the multiple OFDM symbols, or a repetition factor.

In some example embodiments, an apparatus capable of performing the method 1000 (for example, the network device 310) may comprise means for performing the respective steps of the method 1000. The means may be implemented in any suitable form. For example, the means may be implemented in a circuitry or software module.

In some example embodiments, the apparatus comprises: means for transmitting, to a terminal device, information indicating that multiple antenna port sets are time division multiplexed with each other across multiple OFDM symbols of an SRS resource in a slot; and means for receiving, from the terminal device, an SRS on the SRS resource, wherein transmission of the SRS is based on the information.

In some example embodiments, each of the multiple OFDM symbols is associated with one of the multiple antenna port sets, and wherein the multiple OFDM symbols are consecutive in the slot.

In some example embodiments, the apparatus further comprises: means for transmitting, to the terminal device, an indication indicating at least one offset value for the multiple antenna port sets in the slot.

In some example embodiments, the at least one offset value indicates an offset number of OFDM symbols between two adjacent antenna port sets of the multiple antenna port sets in the slot.

In some example embodiments, the at least one offset value comprises multiple offset values, and wherein each of the multiple offset values indicates an offset number of OFDM symbols relative to a first OFDM symbol of the SRS resource.

In some example embodiments, the multiple offset values are represented as a vector with multiple different integer values.

In some example embodiments, the indication is comprised in at least one of: a MAC CE, or a DCI.

In some example embodiments, the apparatus further comprises: means for transmitting, to the terminal device, a further indication indicating that the SRS resource is triggered.

In some example embodiments, each of the multiple OFDM symbols is associated with one of the multiple antenna port sets, wherein the at least one offset value is larger than 0 and the multiple OFDM symbols are non-consecutive in the slot.

In some example embodiments, multiple positions of the multiple OFDM symbols in the slot is determined based on at least one of: a total number of the multiple OFDM symbols, a starting position of a first OFDM symbol among the multiple OFDM symbols, the at least one offset value, or a repetition factor if the repetition is configured.

In some example embodiments, the multiple antenna port sets are mapped into the multiple OFDM symbols based on at least one of: a repetition factor if the repetition is configured, or one or more hopping parameters if the frequency hopping is configured.

In some example embodiments, a number of antenna ports in each of the multiple antenna port sets is determined based on at least one of: a total number of antenna ports at the apparatus, a total number of the multiple OFDM symbols, or a repetition factor.

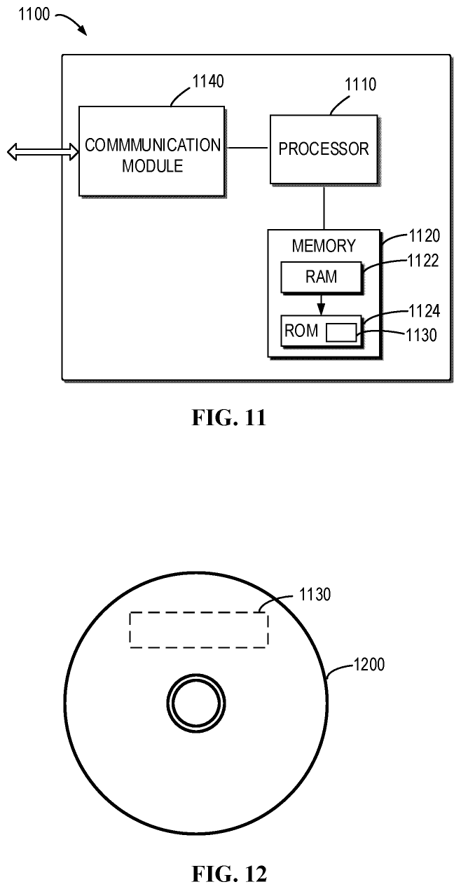

FIG. 11 illustrates a simplified block diagram of a device 1100 that is suitable for implementing some example embodiments of the present disclosure. The device 1100 may be provided to implement the communication device, for example the terminal device 320, or the network device 310 as shown in FIG. 3. As shown, the device 1100 includes one or more processors 1110, one or more memories 1120 coupled to the processor 1110, and one or more communication modules 1140 coupled to the processor 1110.

The communication module 1140 is for bidirectional communications. The communication module 1140 has at least one antenna to facilitate communication. The communication interface may represent any interface that is necessary for communication with other network elements.

The processor 1110 may be of any type suitable to the local technical network and may include one or more of the following: general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The memory 1120 may include one or more non-volatile memories and one or more volatile memories. Examples of the non-volatile memories include, but are not limited to, a Read Only Memory (ROM) 1124, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1122 and other volatile memories that will not last in the power-down duration.

A computer program 1130 includes computer executable instructions that are executed by the associated processor 1110. The program 1130 may be stored in the ROM 1124. The processor 1110 may perform any suitable actions and processing by loading the program 1130 into the RAM 1122.

The embodiments of the present disclosure may be implemented by means of the program 1130 so that the device 1100 may perform any process of the disclosure as discussed with reference to FIGS. 4-10. The embodiments of the present disclosure may also be implemented by hardware or by a combination of software and hardware.

In some example embodiments, the program 1130 may be tangibly contained in a computer readable medium which may be included in the device 1100 (such as in the memory 1120) or other storage devices that are accessible by the device 1100. The device 1100 may load the program 1130 from the computer readable medium to the RAM 1122 for execution. The computer readable medium may include any types of tangible non-volatile storage, such as ROM, EPROM, a flash memory, a hard disk, CD, DVD, and the like.

FIG. 12 illustrates a block diagram of an example of a computer readable medium 1200 in accordance with some example embodiments of the present disclosure. The computer readable medium 1200 has the program 1130 stored thereon. It is noted that although the computer readable medium 1200 is depicted in form of CD or DVD in FIG. 12, the computer readable medium 1200 may be in any other form suitable for carry or hold the program 1130.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to any of FIGS. 9-10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-16. (canceled)

17. An apparatus comprising:
at least one processor; and
at least one memory storing instructions that, when executed by the at least one processor, cause the apparatus at least to:
receive, from a network device, information indicating that multiple antenna port sets are time division multiplexed with each other across multiple orthogonal frequency division multiplexing (OFDM) symbols of a sounding reference signal (SRS) resource in a slot;
map the multiple antenna port sets into the multiple OFDM symbols of the SRS resource in the slot in a time division multiplexed manner based on the information; and
transmit, to the network device, an SRS on the SRS resource, using the multiple antenna port sets.

18. The apparatus of claim 17, wherein the apparatus is caused to map the multiple antenna port sets into the multiple OFDM symbols by:
equally distributing the multiple antenna port sets across the multiple OFDM symbols, wherein each of the multiple OFDM symbols is associated with one of the multiple antenna port sets, and wherein the multiple OFDM symbols are consecutive in the slot.

19. The apparatus of claim 17, wherein the apparatus is further caused to:
receive, from the network device, an indication indicating at least one offset value for the multiple antenna port sets in the slot.

20. The apparatus of claim 19, wherein each of the at least one offset value indicates an offset number of OFDM symbols between two adjacent antenna port sets of the multiple antenna port sets in the slot.

21. The apparatus of claim 19, wherein the at least one offset value comprises multiple offset values, and wherein each of the multiple offset values indicates an offset number of OFDM symbols relative to a first OFDM symbol of the SRS resource.

22. The apparatus of claim 21, wherein the multiple offset values are represented as a vector with multiple different integer values.

23. The apparatus of claim 19, wherein the apparatus is further caused to:
receive, from the network device, a further indication indicating that the SRS resource is triggered.

24. The apparatus of claim 19, wherein the apparatus is caused to map the multiple antenna port sets into the multiple OFDM symbols by:
determining that the at least one offset value is larger than 0; and
based on the determining that the at least one offset value is larger than 0, equally distributing the multiple antenna port sets across the multiple OFDM symbols, wherein each of the multiple OFDM symbols is associated with one of the multiple antenna port sets, and wherein the multiple OFDM symbols are non-consecutive in the slot.

25. The apparatus of claim 19, wherein the apparatus is further caused to:
determine multiple positions of the multiple OFDM symbols in the slot based on at least one of:
a total number of the multiple OFDM symbols,
a starting position of a first OFDM symbol among the multiple OFDM symbols,
the at least one offset value, or
a repetition factor.

26. The apparatus of claim 17, wherein the apparatus is caused to map the multiple antenna port sets into the multiple OFDM symbols by:
determining that a repetition is configured or a frequency hopping is configured; and
based on the determining that the repetition is configured or the frequency hopping is configured, mapping the multiple antenna port sets into the multiple OFDM symbols based on at least one of:
a repetition factor, or
one or more hopping parameters.

27. The apparatus of claim 17, wherein the apparatus is further caused to:
determine a number of antenna ports in each of the multiple antenna port sets based on at least one of:
a total number of antenna ports at the apparatus,
a total number of the multiple OFDM symbols, or
a repetition factor.

28. An apparatus comprising:
at least one processor; and
at least one memory storing instructions that, when executed by the at least one processor, cause the apparatus at least to:
transmit, to a terminal device, information indicating that multiple antenna port sets are time division multiplexed with each other across multiple orthogonal frequency division multiplexing, OFDM, symbols of a sounding reference signal, SRS, resource in a slot; and
receive, from the terminal device, an SRS on the SRS resource, wherein transmission of the SRS is based on the information.

29. The apparatus of claim 28, wherein the apparatus is further caused to:
transmit, to the terminal device, an indication indicating at least one offset value for the multiple antenna port sets in the slot.

30. A method comprising:
receiving, by a terminal device and from a network device, information indicating that multiple antenna port sets are time division multiplexed with each other across multiple orthogonal frequency division multiplexing (OFDM) symbols of a sounding reference signal (SRS) resource in a slot;
mapping, by the terminal device, the multiple antenna port sets into the multiple OFDM symbols of the SRS resource in the slot in a time division multiplexed manner based on the information; and
transmitting, by the terminal device and to the network device, an SRS on the SRS resource, using the multiple antenna port sets.

31. The method of claim 30, comprising:
mapping the multiple antenna port sets into the multiple OFDM symbols by:
equally distributing the multiple antenna port sets across the multiple OFDM symbols, wherein each of the multiple OFDM symbols is associated with one of the multiple antenna port sets, and wherein the multiple OFDM symbols are consecutive in the slot.

32. The method of claim 30, comprising:
receiving, from the network device, an indication indicating at least one offset value for the multiple antenna port sets in the slot.

33. The method of claim 32, wherein each of the at least one offset value indicates an offset number of OFDM symbols between two adjacent antenna port sets of the multiple antenna port sets in the slot.

34. The method of claim 32, wherein the at least one offset value comprises multiple offset values, and wherein each of the multiple offset values indicates an offset number of OFDM symbols relative to a first OFDM symbol of the SRS resource.

35. The method of claim 34, wherein the multiple offset values are represented as a vector with multiple different integer values.

36. The method of claim 32, comprising:
receiving, from the network device, a further indication indicating that the SRS resource is triggered.
